(19) United States
(12) Patent Application Publication
(10) Pub. No.: US 2014/0287792 A1
(43) Pub. Date: Sep. 25, 2014

(54) METHOD AND APPARATUS FOR NEARBY GROUP FORMATION BY COMBINING AUDITORY AND WIRELESS COMMUNICATION

(71) Applicant: NOKIA CORPORATION, Espoo (FI)

(72) Inventors: Aleksi Roope Rainisto, Helsinki (FI); Kari J. Leppänen, Helsinki (FI); Tuomas Keränen, Espoo (FI)

(73) Assignee: Nokia Corporation, Espoo (FI)

(21) Appl. No.: 13/849,812

(22) Filed: Mar. 25, 2013

(51) Int. Cl. H04W 4/08

(52) U.S. Cl. CPC H04W 4/08
USPC 455/519

(57) ABSTRACT

An approach is provided for group formation based on a synchronized response mechanism. A group platform may determine a request to form at least one group of one or more devices. Then, the group platform may cause, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time. Then, the group platform causes, at least in part, a formation of the at least one group comprising the one or more devices that provide at least one response signal in reply to the at least one audio signal, the at least one visual signal, or a combination thereof at least substantially currently with the at least one synchronized response time.

### BACKGROUND

Service providers and device manufacturers (e.g., wireless, cellular, etc.) are continually challenged to deliver value and convenience to consumers by, for example, providing compelling network services. One area of interest has been the development of forming groups for secure communication. For example, a person may want to share a presentation with all the people within a certain room. The person may then manually identify each of the people within a certain room, one by one, to form a group for sharing. While devices may sense proximate devices, wireless signals pass through walls, ceilings, and floors, picking up people outside a given room or area so that group formation by wireless signals may include people outside of a given room. As a result, content providers face significant challenges using wireless signals to form groups that reflect the users in a physical space.

### Some Example Embodiments

Therefore, there is a need for an approach for group formation based on a synchronized response mechanism.

According to one embodiment, a method comprises determining a request to form at least one group of one or more devices. The method also comprises causing, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time. The method further comprises causing, at least in part, a formation of the at least one group comprising the one or more devices that provide at least one response signal in reply to the at least one audio signal, the at least one visual signal, or a combination thereof at least substantially concurrently with the at least one synchronized response time.

According to another embodiment, an apparatus comprises at least one processor, and at least one memory including computer program code for one or more computer programs, the at least one memory and the computer program code configured to, with the at least one processor, cause, at least in part, the apparatus to determine a request to form at least one group of one or more devices. The apparatus is also caused to cause, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time. The apparatus is further caused to cause, at least in part, a formation of the at least one group comprising the one or more devices that provide at least one response signal in reply to the at least one audio signal, the at least one visual signal, or a combination thereof at least substantially concurrently with the at least one synchronized response time.

According to another embodiment, a computer-readable storage medium carries one or more sequences of one or more instructions which, when executed by one or more processors, cause, at least in part, an apparatus to determine a request to form at least one group of one or more devices. The apparatus is also caused to cause, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time. The apparatus is further caused to cause, at least in part, a formation of the at least one group comprising the one or more devices that provide at least one response signal in reply to the at least one audio signal, the at least one visual signal, or a combination thereof at least substantially concurrently with the at least one synchronized response time.

According to another embodiment, an apparatus comprises means for determining a request to form at least one group of one or more devices. The apparatus also comprises means for causing, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time. The apparatus further comprises means for causing, at least in part, a formation of the at least one group comprising the one or more devices that provide at least one response signal in reply to the at least one audio signal, the at least one visual signal, or a combination thereof at least substantially concurrently with the at least one synchronized response time.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of group formation based on a synchronized response mechanism, according to one embodiment;

FIG. 2A is a diagram of the components of a group platform, according to one embodiment;

FIG. 2B is a diagram of the components of a synchronization platform, according to one embodiment;

FIG. 3 is a flowchart of a process for forming groups based on a synchronized response mechanism, according to one embodiment;

FIG. 4 is a flowchart of a process for determining whether response signals are synchronized, according to one embodiment;

FIG. 5 is a flowchart of a process for confirming participation in the group, according to one embodiment;

FIG. 6 is a diagram of a typical wireless signal, according to one embodiment;

FIG. 7 is a diagram 700 of a wireless signal coupled with an audio signal, according to one embodiment;

FIG. 8 is a diagram 800 of the signal flow for a case of typical group formation, according to one embodiment;

FIG. 9 is a scenario 900 of audio files in a call-response format, in one embodiment;

FIG. 10 is a scenario 1000 of audio files in a call-unison format, in one embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for group formation based on a synchronized response mechanism are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

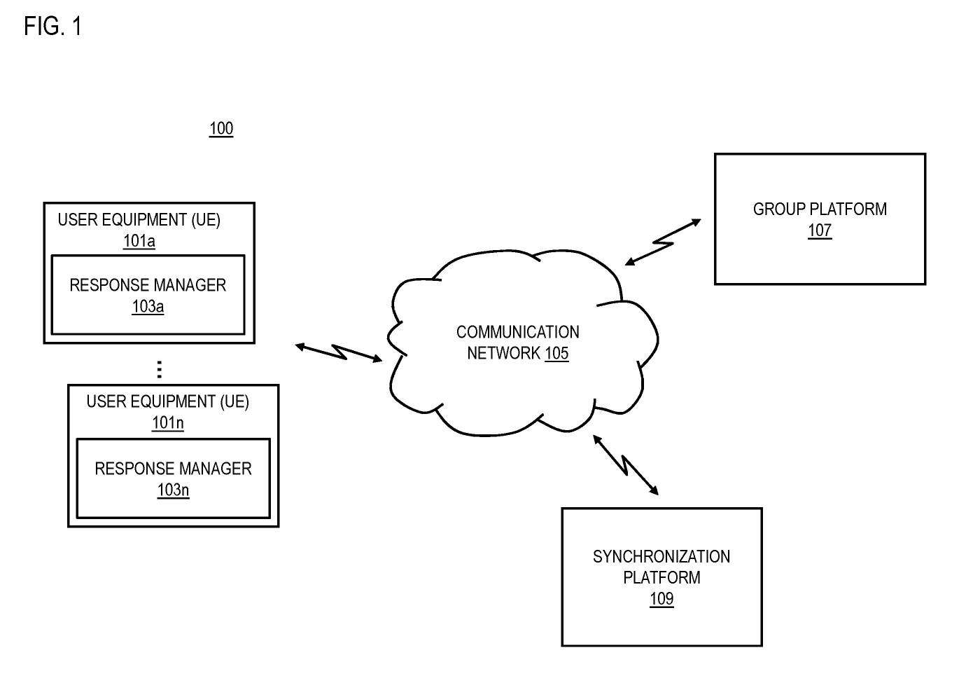

FIG. 1 is a diagram of a system capable of group formation based on a synchronized response mechanism, according to one embodiment. Service providers and device manufacturers (e.g., wireless, cellular, etc.) are continually challenged to deliver value and convenience to consumers by, for example, providing compelling network services. One area of interest has been the development of forming groups for secure communication. For example, people interact with each other within various physical environments that provide an understanding of security or relationship among the people present in the physical context of a room. For instance, a person may want to have his device be in communication with another person's device, where the other person is in the same room. One such scenario may be where the person wants to share a presentation or picture with all the people within a certain room.

Options for group formation include a person manually identifying each user to add to a group, one by one. For example, if a group is comprised of people within a room, a team leader may manually add each person or device as a group participant. While devices may sense proximate devices, the devices sensed may not reflect the interaction of people associated with the devices. For example, wireless signals pass through walls, ceilings, and floors, picking up people outside a given room or area. The grouping identified by the wireless signals of a device, then, may not reflect the interaction of users within a physical space. As a result, content providers face significant challenges using wireless signals to form groups that reflect the users in a physical space.

To address this problem, a system 100 of FIG. 1 introduces the capability to form groups based on a synchronized response mechanism. In one embodiment, the system 100 may use audio signals in conjunction with wireless signals to limit access to a group according to users' physical relationships. System 100 may act on the premise that devices that couple wireless discovery with sound, are within the same social context. For example, the system 100 may permit creation of groups based on local proximity, rather than members being manually added. To limit the group creation to a local proximity that corresponds to a user's interactions within a room, the system 100 may limit group entry similar to the effect of a soundproof room. Soundproof rooms insulate sound within a certain area. Analogously, system 100 may isolate wireless signals for group formation to extend only to users within a given area, both so that the group does not disturb other users and to keep the group secure. In one embodiment, system 100 may use BT and Near Field Communications (NFC) to pair locally proximate devices.

For example, the system 100 may form a group by causing a device to prompt for response signals and automatically make the group based on the response signals received. In such a case, no manual or previous pairing is required. Instead, the system 100 may determine devices suitable to be group participants, depending on response signals received from the devices. In one embodiment, system 100 may include devices A, B, C, D, and E. Device A may be a user that wants to initiation group formation by connecting with nearby devices. Devices B, C, and D may be within the same room within wireless range, while device E is within wireless range but not in the same room. In one embodiment, Device A may prompt devices within range to “listen.” The system 100 may then cause devices detected within Device A's wireless range to turn their microphones on to “listen.”

In one embodiment, Device A may then play an audio signal as a challenge signal to join a group. Devices B, C, and D that hear the signal may transmit a response signal reporting what they had heard. In one embodiment, the response signal among all the Devices B, C, and D is synchronized. In one embodiment, device A may specify a time and cause all the devices B, C, and D to provide the response signal at the same time. Device A may then verify the correctness of the response signal in each of the devices playing back what they had heard. System 100 may then create a group of the devices that played a response signal at the specified time that corresponds to the initial audio signal from Device A. In one embodiment, Device E will not send a response signal at the same time as devices B, C, and D because, despite being within wireless range, Device E may be physically farther away, outside of the room. System 100 may then sense that Device E either did not respond, or Device E's response was not synchronized with that of Devices B, C, and D since it is not as proximate to Device A. In one embodiment, devices that do not hear the audio signal from Device A fall back into its normal operation, continuing in its functions outside of the group.

In one embodiment, the signal from Device A may further include varying criteria, where devices that hear the signal must respond with a response signal that includes the varying criteria heard from Device A. Then, the analysis for correctness may also include whether the responses correctly incorporate the varying criteria. In one embodiment, the varying criteria may include elements used to adjust a challenge signal. For example, where a challenge signal is an audio tune, the criteria may include one or more of the following: adjusting the start time of the tune, the tempo of the tune, the pitch of the tune, adding a watermark to the tune, and/or adjusting the melody of a tune. For example, for adjusting the start time of the tune, the system 100 may include a random time window where Device A will start to play a sound between 0-1 seconds, for instance, starting at 570 ms. The system 100 may then dictate that other devices must transmit response signals when they start to hear the sound. This may adjust for latency issues. In one scenario, Device A may start a tune as a challenge signal, then devices B, C, and D may join in at times specified by Device A, with respective response signals harmonizing with the challenge signal. In other words, the challenge and response signals may form a call-and-response type of interaction.

For adjusting the tempo of the tune, the system 100 may make a tune slightly faster or slower than an original tempo. The response signal may then include the tempo of the sound heard. Similarly for adjusting the pitch, the system 100 may play the tune in a key slightly higher or lower than the usual key. The response signal may be adjusted to the pitch of such varying criteria. Watermarking sound may include making changes not discernible to the human ear. Spread spectrum watermarking may allow for discerning of different device identification codes, despite the signals being transmitted simultaneously. Lastly, adjusting the melody of a tune may include changing the actual substance of the tune, with the response signals incorporating the change. For example, system 100 may set varying criteria such that the response signals of all the devices responding synchronized, in unison, may be harmonized. In one embodiment, the signal may also be an audio signal, although one outside of human hearing range.

In one embodiment, system 100 may cause Device A to time the response signal to avoid eavesdropping devices. To time the response signals, Device A may require that each device add a specific code to the emitted sound so that participating devices may identify themselves. For example, far away eavesdropping devices may have excessive travel time for their sound response signal. If the eavesdropping device is far away, the sound simply cannot propagate fast enough to respond in synchronization with the nearby devices within the same room. As such, system 100 timing response signal emissions may permit grouping of only devices physically proximate one another. Due to the identification code, the system 100 may also verify that the timed emissions are from participant devices.

Also, since Device A specified a time at which to provide the response signal, synchronization of the response signals may offer security without requiring encryption. Generally with encryption, security within a group would involve a device, such as Device A, passing a secure key to other devices in a room, then the other devices responding to encrypt their responses with the key. However, the devices may not be able to transmit enough data to do a secure key and a small key may be hacked. The synchronization may prevent a hostile device from successfully entering the group because the device will not have a chance to know the proper response signal by Device A's specified time. To respond with the proper response signal, a hostile device, for example Device E, would have to first hear the proper response signal. However, since the proper response signals are not played until the specified time (at which point all the response signals are played at the same time), Device E may not have a chance to copy the proper response signal prior to the specified time. Thus, even if Device E comes to know the proper response signal, Device E's response may not be synchronized with that of the other devices, at the time specified by Device A. Thus, system 100 may recognize Device E as not one of the devices intended to be within the group.

In one embodiment, the security of system 100 may be adjusted to various levels. In one embodiment, system 100 may include a social check within the group after group formation to act as a layer of security. For example, if users see more people belonging to the group than are in the room and/or foreign names, system 100 may cause Device A to re-try the group formation.

In a further embodiment, system 100 may cause all the devices to play an additional feedback that indicates the status of group formation. For example, the status may include whether group formation succeeded or failed. For example, if Devices B, C, and D all play a harmonized response signal in unison, group formation is successful and Devices B, C, and D may further have a blinking light display showing participation in a group setting. If Device B fails to join the group, system 100 may receive a displayed notification of failed group formation.

In one embodiment, the challenge signal may be of a different medium than the response signal. For example, the challenge signal may include a sound emitted from Device A. Response signals, however, may include a visual display including a visual notification on a user device's screen, a light, and/or a sequence of photos. In another embodiment, the sounds may be inaudible to the human ear. For example, response signals may be ultrasounds where users may not have to audibly experience the synchronized response. In another embodiment, the response signals may form a fun user experience, where challenge signals are configured to cause response signals that give a “concert” of overlapping, harmonizing, audio feedback.

As shown in FIG. 1, the system 100 comprises a user equipment UE 101a-101n (or UEs 101) having connectivity to response managers 103a-103n, group platform 107, and synchronization platform 109 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the response managers 103 may submit response signals in response to requests to form at least one group of one or more devices. For example, the response managers 103 may receive challenge signals and replicate the challenge signals a response signals. In one scenario, response managers 103 are configured to monitor for various types of challenge signals and recognize responses requested by each of the challenge signals. In another example, the response managers 103 may determine requests for response signals that include variations in the challenge signal. The response managers 103 may then create response signals that apply the requested variations.

In one embodiment, the group platform 107 may issue the challenge signal to form at least one group. For example, the group platform 107 may determine initiation of a data sharing session or conferencing between devices in a physical space and determine a request to form a group. In another embodiment, the group platform 107 may specify, with the challenge signal, at least one synchronized response time. The response time may dictate to UEs 101 and response managers 103, when they must submit the response signals. Submitting the response signals at the time specified by the group platform 107 causes the response signals to be synchronized. Properly submitting response signals in synchronization permits the group platform 107 to determine what devices to include in a group.

In a further embodiment, the group platform 107 formation of groups of UEs 101 may further include determining the validity of a response signal. For example, the group platform 107 may include, in the challenge signal, an encoding of validity criteria that the response signal must also include. For example, the group platform 107 may include validity criteria in a challenge signal in the form of a tune, where a response signal must be comprised of the same tune, but at a lower pitch. Then, the group platform 107 may determine that only the UEs 101 play the tune at the correct, lower pitch are valid and form a group out of only the valid UEs 101.

In a further embodiment, the group platform 107 may determine a status signal indicating the success or failure of the formation of the at least one group with respect to each of the UEs 101. For example, the group platform 107 may determine that a UE 101a sends a response signal at an incorrect pitch from the one required by the challenge signal. The group platform 107 may then inform the UE 101a of failed group entry by causing UE 101a to generate a failure message notification display.

In one embodiment, the synchronization platform 109 may determine that response signals are synchronized. In other words, the synchronization platform 109 may receive all the response signals and process the collection of signals for the group platform 107 to then determine response signal validity. In one embodiment, the synchronization platform 109 may also be the intermediary between response managers 103 and group platform 107, where the synchronization platform 109 prompts the response managers 103 to monitor for challenge signals from group platform 107. For example, the synchronization platform 109 may determine multiple UEs 101 in close proximity and thus make the inference that users may soon initiate group formation. The synchronization platform 109 may then trigger response managers 103 to start monitoring.

By way of example, the UE 101, response managers 103, group platform 107, and synchronization platform 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

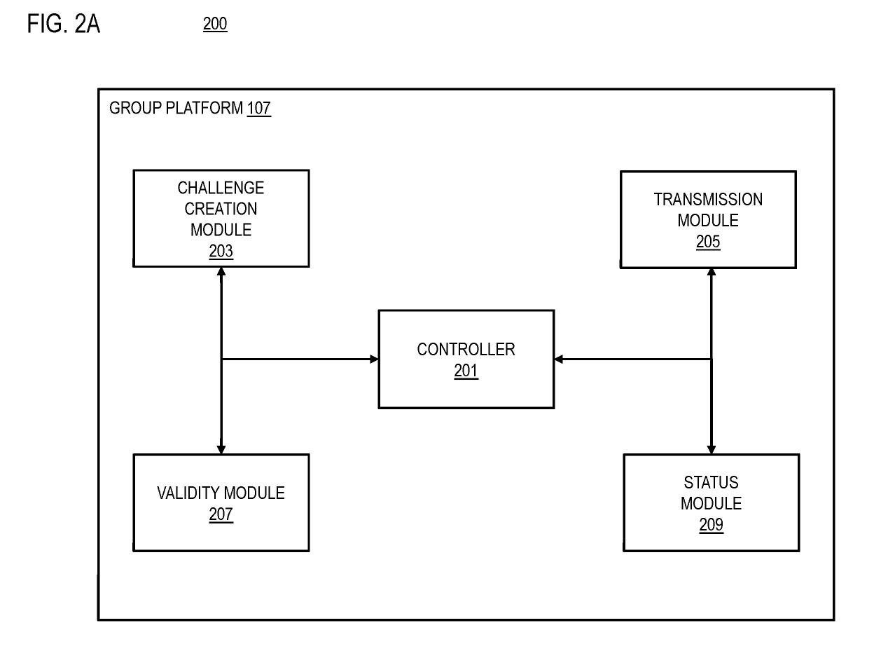

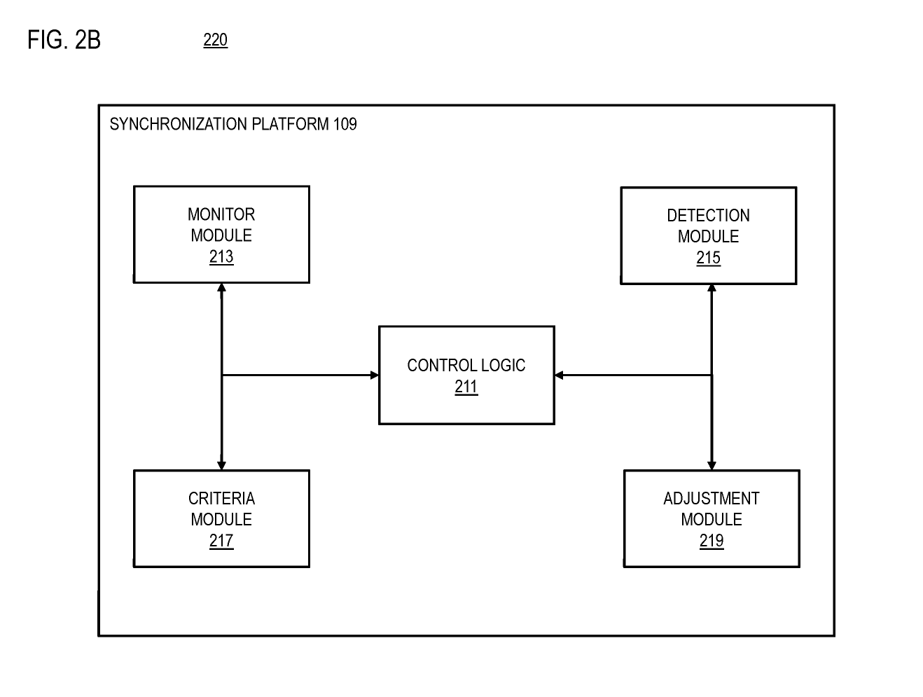

FIG. 2A is a diagram of the components of the group platform 107, according to one embodiment. By way of example, the group platform 107 includes one or more components for providing group formation based on a synchronized response mechanism. It is contemplated that the functions of these components may be combined in one or more components or performed by other components of equivalent functionality. In this embodiment, the group platform 107 includes controller 201, challenge creation module 203, validity module 207, transmission module 205, and status module 209.

In one embodiment, the controller 201 and challenge creation module 203 may generate the challenge signal. For example, the controller 201 and challenge creation module 203 may encode validity criteria in the challenge signal. In one embodiment, the controller 201 and challenge creation module 203 may determine the validity criteria or complexity of validity criteria for a particular challenge signal based on various factors include user preference, context information, network history, device capability, or a combination thereof. For example, if the controller 201 and challenge creation module 203 detect that the physical space or possible group is very small and compact, the controller 201 and challenge creation module 203 may create a challenge signal with validity criteria including only latency for the response signal. However, where the controller 201 and challenge creation module 203 detect potential formation of a large group, the generated challenge signal may include several layers of validity criteria. For example, the controller 201 and challenge creation module 203 may encode in the challenge signal, prompts for response signals that would respond, in combination, to form an elaborate harmony, melody, or a combination thereof.

In one embodiment, the controller 201 and transmission module 205 may transmit a challenge signal to one or more devices. For example, the controller 201 and transmission module 205 may detect that a UE 101a wants to form a group. UE 101a may then request group formation from the group platform 107, whereupon controller 201 and transmission module 205 may transmit a challenge signal on behalf of UE 101a. In one embodiment, the controller 201 and transmission module 205 may determine devices proximate UE 101a and transmit the challenge signal to those devices.

In one embodiment, the controller 201 and the validity module 207 may determine the validity of received response signals. For example, where the controller 201 and validity module 207 encoded the challenge signal with a validity criteria, the controller 201 and validity module 207 may form a matching of received versus expected response signals. The controller 201 and validity module 207 may then form a group of the devices that emitted valid response signals.

In one embodiment, the controller 201 and validity module 207 may further also keep track of devices that responded with invalid response signals. For example, invalid response signals may be accidental responses from devices not intending to participate, devices that ought to be in the group but somehow emit faulty, invalid signals, and/or devices that do not belong in the group and are maliciously attempting to participate. For example, after controller 201 and transmission module 205 cause transmission of a challenge signal and determine a chorus of response signals from various devices. The controller 201 and validity module 207 may find a pattern of a certain device sending response signals that fail to meet challenge signal validity criteria. Then, the controller 201 and validity module 207 may further investigate as to whether the device is a malicious device intentionally threatening group security.

In one embodiment, the controller 201 and status module 209 may return feedback to devices as to whether group formation succeeded or failed. In one embodiment, the controller 201 and status module 209 may work with the validity module 207 to see both the devices that responded with valid and the devices that responded with invalid response signals. In one embodiment, the status module 209 may contain a further mechanism to check whether even a device that sent an invalid response signal, should be in a group. To do this, the status module 209 may take into account user information with respect to associations with the initiating device, social networks of the initiating device, or a combination thereof. In one embodiment, the controller 201 and status module 209 may then issue a signal to devices that enter the group, indicating successful group formation. In one embodiment, the controller 201 and status module 209 may send a signal also to devices that responded, but invalidly, showing failure to join the group. In another embodiment, the controller 201 and status module 209 may not inform unsuccessful devices, under the assumption that the devices were not intended to join the group. In one embodiment, the challenge signal, response signal, group formation signal may all be overlapping signals that comprise a melody, a harmony, or a combination thereof

FIG. 2B is a diagram of the components of the synchronization platform 109, according to one embodiment. By way of example, the synchronization platform 109 includes one or more components for determining whether response signals occurred in synchronization. It is contemplated that the functions of these components may be combined in one or more components or performed by other components of equivalent functionality. In this embodiment, the synchronization platform 109 includes control logic 211, monitor module 213, detection module 215, criteria module 217, and adjustment module 219.

In one embodiment, the control logic 211 and monitor module 213 may cause devices to monitor for challenge signals. For example, the control logic 211 and monitor module 213 may sense a concentration of devices or determine a physical bounded area, and prompt devices or UEs 101 to turn on their microphones. In one embodiment, the control logic 211 and monitor module 213 may be sensitive to the type of challenge signals a particular UE 101a capable of emitting and prompt other UEs 101b-101n to turn on functionality to receive any challenge signals UE 101a may emit.

In one embodiment, the control logic 211 and detection module 215 may determine response signals arriving from various UEs 101. In one embodiment, the control logic 211 and detection module 215 may collect response signals from UEs 101 for analysis and processing. In one embodiment, the control logic 211 and detection module 215 may determine the synchronized response time specified by challenge signal transmission and collect response signals at that particular time. In another embodiment, the control logic 211 and detection module 215 may collect signals concurrently sent at least substantially concurrently with the at least one synchronized response time.

In one embodiment, the control logic 211 and criteria module 217. may determine a timing criteria dictated by the group platform 107. For example, the group platform 107 may dictate timing criteria where all response signals must begin 10 ms after the challenge signal sounds. Then, the control logic 211 and criteria module 217 may determine response signals that occur 10 ms after the challenge signal or substantially concurrently at 10 ms. In one embodiment, the control logic 211 and criteria module 217 may also inform the group platform 107 as to the reasonability of the timing criteria. For example, the control logic 211 and criteria module 217 may determine that UEs 101 do not have the capability to react such that they meet the timing criteria. For example, latency issues rather than physical distance may cause UEs 101 to fail to meet timing criteria. The control logic 211 and criteria module 217 may then inform group platform 107 of the capabilities of UEs 101 such that reasonable timing criteria are set.

In one embodiment, the control logic 211 and adjustment module 219 may determine an adjustment of elements in a response signal, for example, latency, tempo, pitch, melody, or a combination thereof. For example, the group platform 107 may transmit challenge signals requesting response signals with certain elements of the challenge signals adjusted. The control logic 211 and adjustment module 219 collect the response signals with adjustments that comply with the challenge signal request.

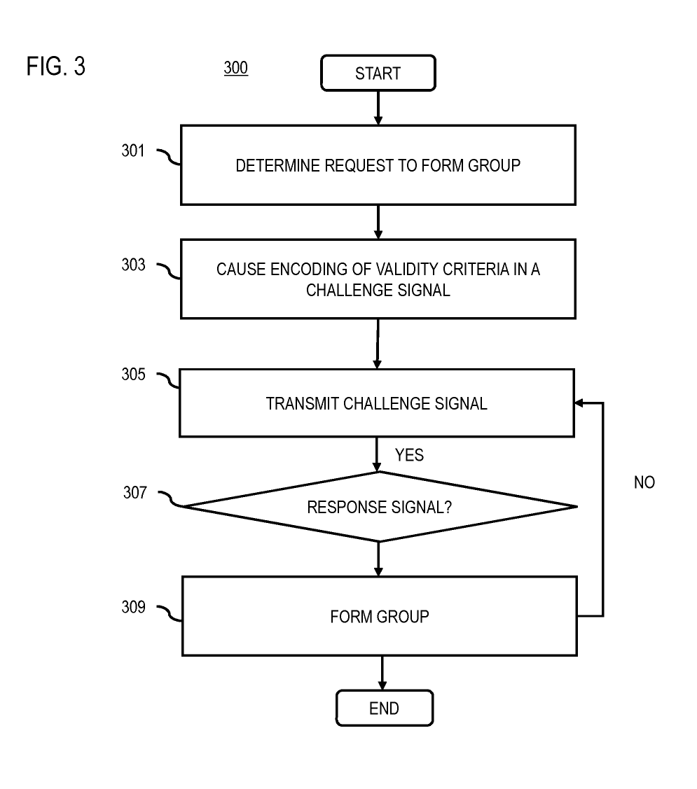

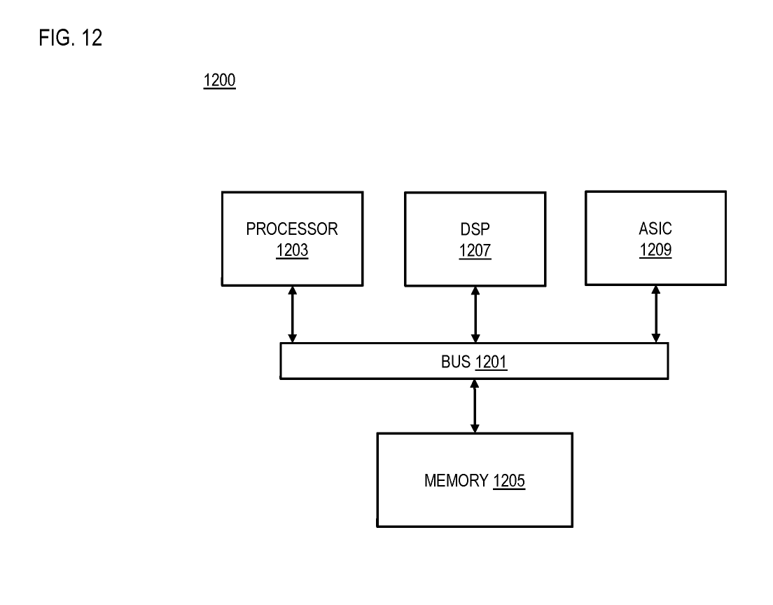

FIG. 3 is a flowchart of a process for forming groups based on a synchronized response mechanism, according to one embodiment. In one embodiment, the group platform 107 performs the process 300 and is implemented in, for instance, a chip set including a processor and a memory as shown in FIG. 12. In step 301, the controller 201 may determine a request to form at least one group of one or more devices. For example, the controller 201 may sense the initiation of a meeting or request to share information within a set of devices. In one embodiment, the controller 201 may cause, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time. In one instance, one device initiates group formation, controller 201 determines the device's request to form a group, and triggers creation of a challenge signal.

For example, the controller 201 may cause, at least in part, an encoding of one or more validity criteria in the at least one challenge signal and determine a validity of at least one response signal based, at least in part, on whether the at least one response signal includes or meets the one or more validity criteria (step 303). In one embodiment, the validity criteria may include a time criteria, where the response signal must occur within a given window of time. In one embodiment, the controller 201 may transmit the challenge signal after encoding the challenge signal with validity criteria (step 305). For instance, the controller 201 may send the challenge signal to an entire area that a wireless signal may cover such that all the devices within the area receive the signal.

Then, the controller 201 may cause, at least in part, a formation of the at least one group comprising the one or more devices that provide at least one response signal in reply to the at least one audio signal, the at least one visual signal, or a combination thereof at least substantially concurrently with the at least one synchronized response time (steps 307 and 309). In one embodiment, devices proximate the device that initiated group formation may transmit a response signal within the synchronized response time due to the time necessary for sound to travel. Devices farther away, however, may fail to respond in synchronization due to their distance. In one embodiment, devices within a physical room may join the group while devices outside the room would be unable to give its response signal at the exact same time as devices within the room, due to the timing at which it received the challenge signal. As such, the process 300 may permit a virtual group to reflect the environment of a physical group.

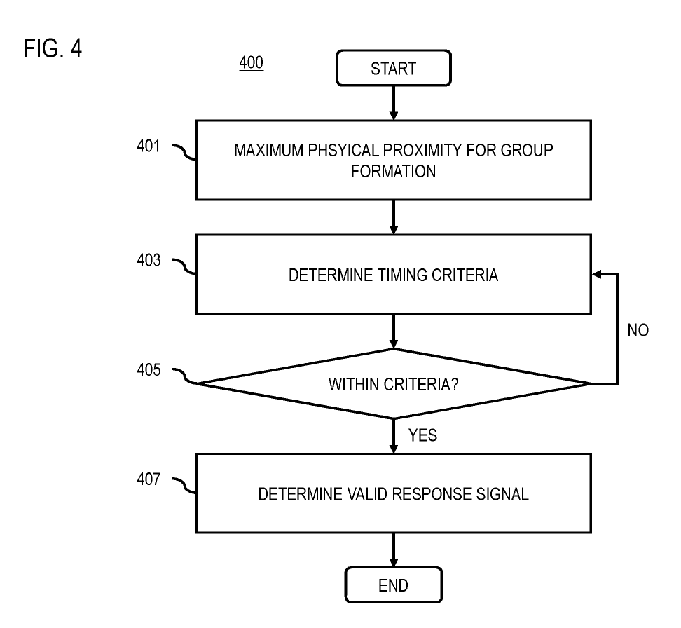

FIG. 4 is a flowchart of a process for determining whether response signals are synchronized, according to one embodiment. In one embodiment, the synchronization platform 109 performs the process 400 and is implemented in, for instance, a chip set including a processor and a memory as shown in FIG. 12. In step 401, the control logic 211 may determine a physical proximity for group formation. For example, for step 403, the control logic 211 may determine validity of the at least one response signal based, at least in part, on whether a timing of the at least one audio signal, the at least one visual signal, or a combination thereof comprising the at least one response signal meets one or more criteria.

Then, the control logic 211 may determine the timing criteria based, at least in part, on a maximum physical proximity for the formation of the at least one group. For example, the perimeter of a room or space may define the maximum physical proximity for the formation of the at least one group. Then, the control logic 211 may determine the timing criteria such that the timing criteria necessitates that the devices emitting the response signals to be within the room. Otherwise, the devices could not respond in time to meet the timing criteria. Should the timing of a response signal fall within the criteria, the control logic 211 may interact with group platform 107 to form a group (steps 405 and 407).

For instance, the control logic 211 may cause, at least in part, a transmission of at least one message for the one or more devices to monitor for the at least one challenge signal, wherein the at least one message includes, at least in part, the at least one synchronized response time. For example, the control logic 211 may prompt response managers 103a-103n to monitor for the challenge signal and then send a signal to the response managers 103a-103n when a challenge signal is sent to respective UEs 101a-101n. Then in one case, the control logic 211 may further cause, at least in part, an adjustment of one or more elements of the at least one response signal, wherein the one or more elements include, at least in part, a latency, a tempo, a pitch, a melody, or a combination thereof. In such a case, the control logic 211 may determine that response signals are adjusted according to element adjustments set out by the challenge signal. In one embodiment, the adjustments may take into account the devices available and their functions. Upon determining that UEs 101 response with the adjusted response signals within the timing criteria, the control logic 211 may inform the group platform 107 of the UEs 101 that may participate in a group.

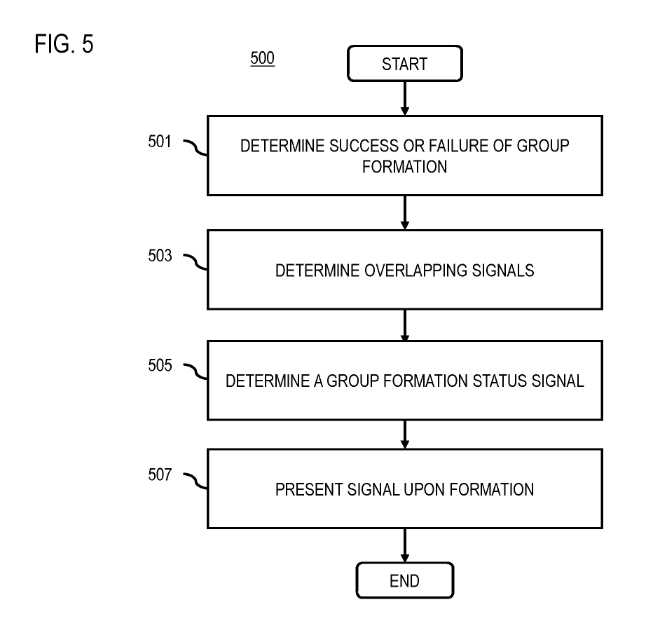

FIG. 5 is a flowchart of a process for confirming participation in the group, according to one embodiment. In one embodiment, group platform 107 performs the process 500 and is implemented in, for instance, a chip set including a processor and a memory as shown in FIG. 12. In step 501, the controller 201 may cause, at least in part, a presentation of at least one group formation status signal by the one or more devices based, at least in part, on the formation of the at least one group, a validity of the at least one response signal, or a combination thereof. This step may occur wherein the at least one group formation status signal indicates a success or a failure of the formation of the at least one group with respect to one or more devices on a device-by-device basis. In other words, the controller 201 may first determine the success or failure of group formation with respect to one or more devices for step 501.

In another embodiment, the controller 201 may determine a status signal wherein the at least one challenge signal, the at least one response signal, the at least one group formation status signal, or a combination thereof are presented in a combination of one or more overlapping signals (step 503). In one instance, such a combination of overlapping signals may be wherein the combination of one or more overlapping signals comprise, at least in part, a melody, a harmony, or a combination thereof. Thus, upon determining the success or failure of formation, the controller 201 may determine a combination of overlapping signals to serve as a status signal and present the signal to the devices (step 505). The devices and users associated with devices may then have an indication of whether they successfully joined a group.

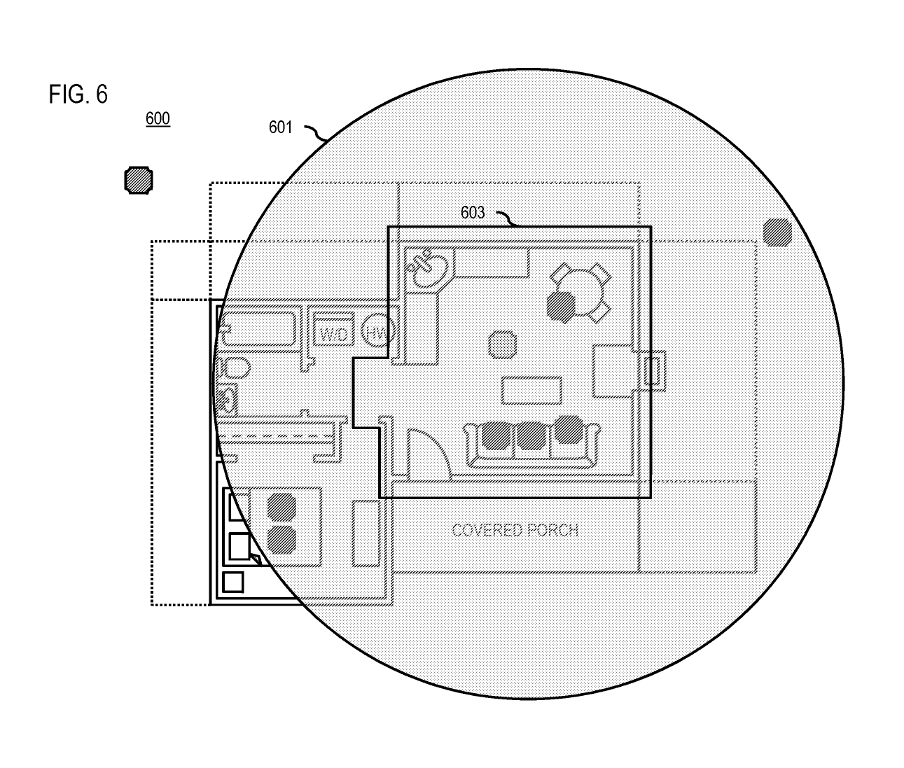

FIG. 6 is a diagram 600 of a typical wireless signal, according to one embodiment. In one embodiment, the area 601 may illustrate the coverage of a wireless signal, or area within which devices may initiate contact with each other using a wireless signal. In other words, area 601 shows an area of wireless signal penetration. Area 603 may indicate the boundary of a room or a particular subset of area 601. In one embodiment, area 603 may stand for a physical area distinct from the wireless coverage shown by area 601. In one embodiment, a wireless signal may exist within area 603, but it is not bound within area 603. Instead, the wireless signal extends past area 603 to extend throughout area 601.

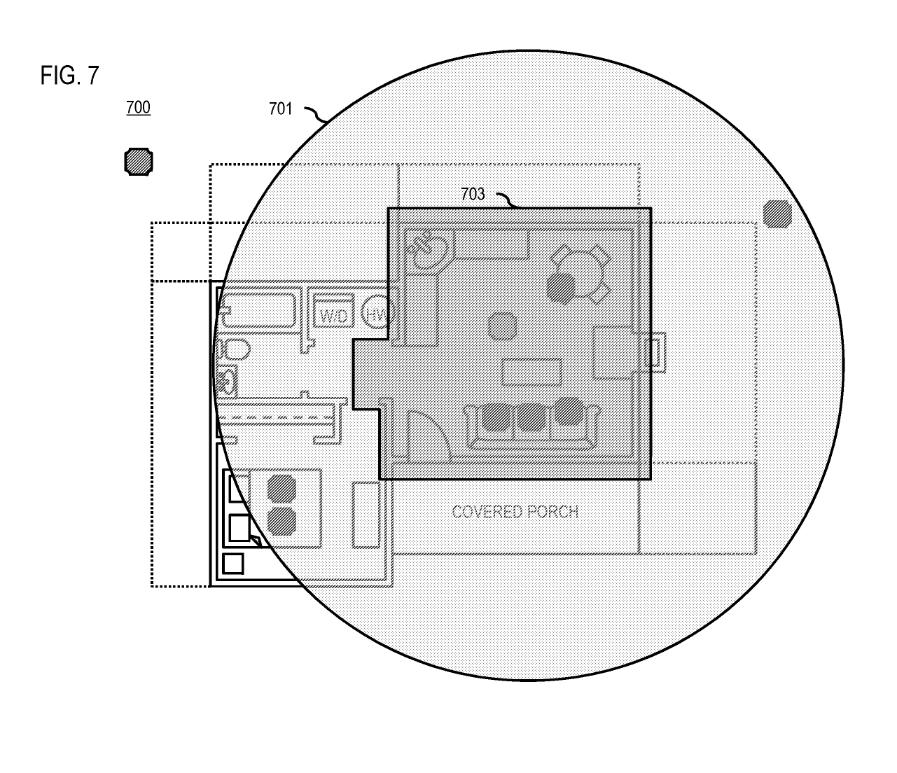

FIG. 7 is a diagram 700 of a wireless signal coupled with an audio signal, according to one embodiment. In one embodiment, area 701 is the area of wireless signal penetration. Then, area 703 shows the area of bounded wireless signal where an area of wireless signal penetration corresponds to a bounded physical space. For example, area 703 may be the area of a room. Then, in this case, the area of wireless signal penetration is confined to the room defined by area 703. In one embodiment, the area 703 demonstrates an isolation of wireless signal within the bounded area, as permitted by the use of the synchronized response mechanism previously described. Use of the synchronized response requires that group participants be in a certain proximity of the initiating device, for example, in the scenario where a group of users is within area 703.

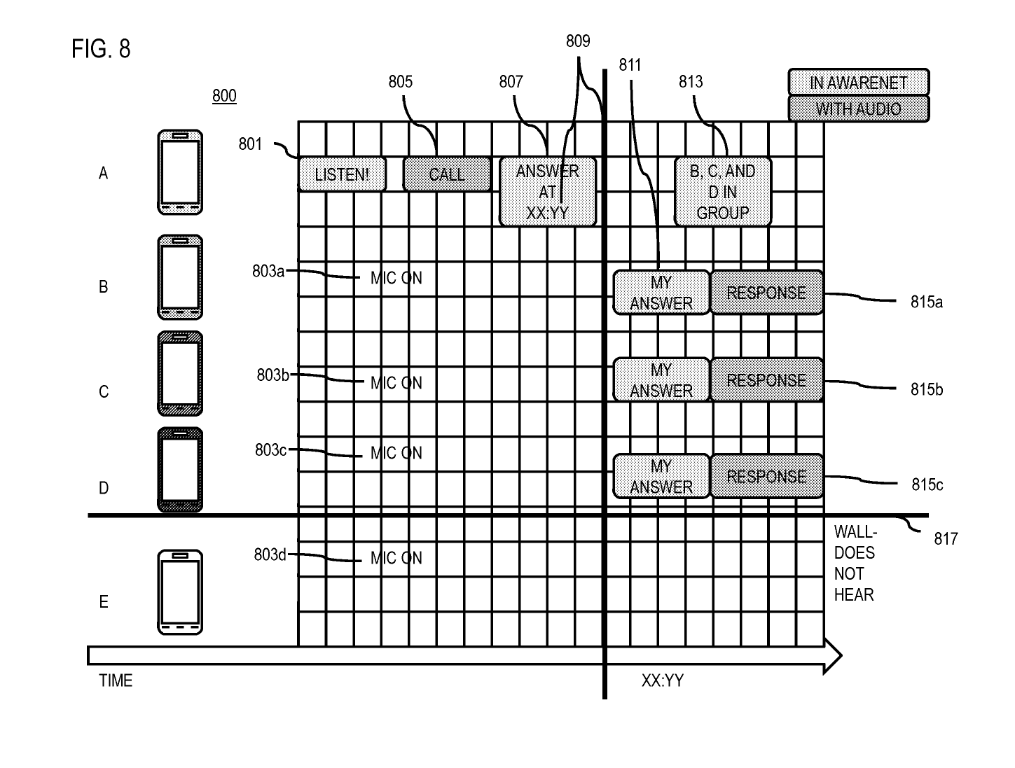

FIG. 8 is a diagram 800 of the signal flow for a case of typical group formation, according to one embodiment. In one embodiment, device A may initiate a “listen” signal 801, causing neighboring devices B-E to start monitoring 803a-803d, for example, by switching their microphones on. Then, device A may issue a challenge signal 805 to initiation group formation. With the challenge signal 805, device A may transmit a signal 807 specifying a particular response time 809. At the specified response time 809, devices B-E may initiate response signals 811 in synchronization. Then, device A may determine receipt of response signals 811 from devices B-E and form a group 813 from the determination. After group formation, device A may cause transmission of status signals 815a-815c notifying devices B-D of their participation in a group. In one embodiment, wall 817 prevents device E from hearing the challenge signal 805 and therefore responding and participating in the group. In one embodiment, wall 817 may be a physical wall.

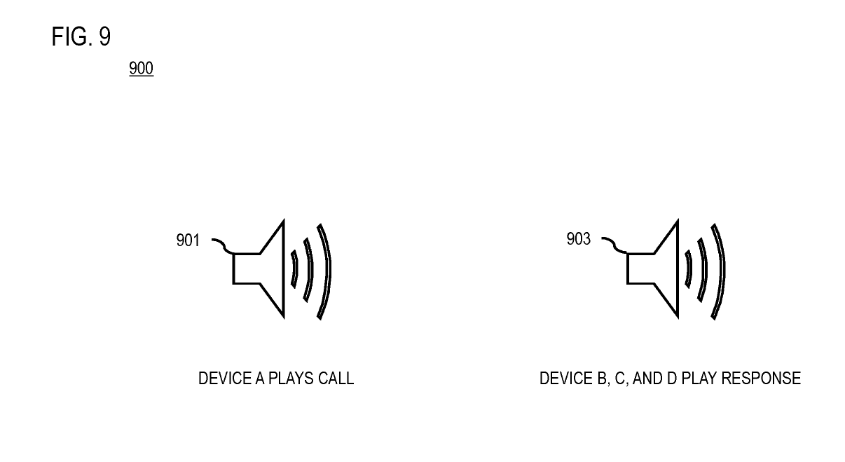

FIG. 9 is a scenario 900 of audio files in a call-response format, in one embodiment. In one embodiment, device A, a group formation initiating device, may play a call 901. In one instance, devices B, C, and D may play back a response signal, call 903 after hearing call 901. In one embodiment, only call 901 is audible. Call 903 may be audible or non-audible, for example, call 903 may be at a frequency that humans cannot hear. For example, call 903 may be an ultrasound so that users may join a group and receive status signals of successful group formation, but not be bombarded with sounds from various devices.

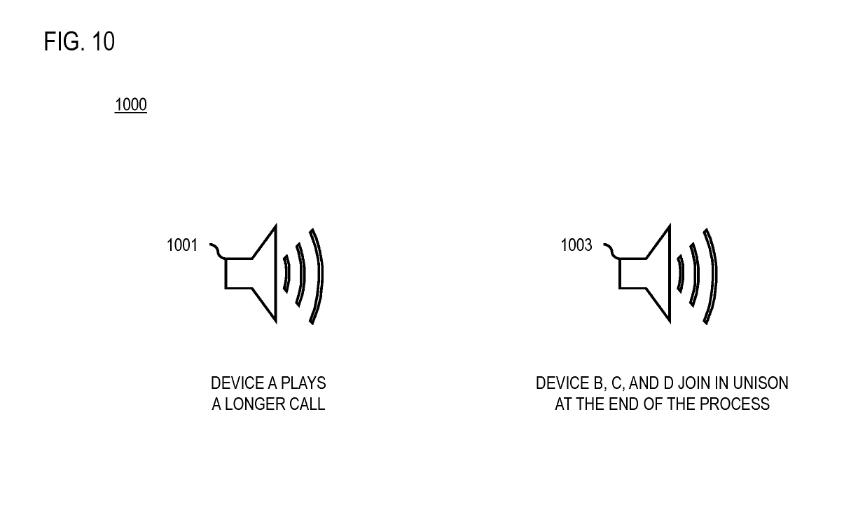

FIG. 10 is a scenario 1000 of audio files in a call-unison format, in one embodiment. For example, device A may play a call 1001 to cause group formation. Call 1001 may continue as devices B, C, and D join in with call 1003. In other words, calls 1001 and 1003 may go on in unison at some points. For example, calls 1001 may require that the responding call 1003 be adjusted with a start time 500 ms after the start of call 1001. Such a lag may account for any latency between devices B, C, and D in receiving call 1001. Then, at 500 ms, devices B, C, and D would join call 1001 so that the two calls overlap. In another embodiment, device A may also adjust the challenge signal with call 1001 such that calls 1003 vary the tune of call 1001. For example, calls 1003 may join in at 500 ms, harmonizing with call 1001. Such an embodiment may create a pleasant user experience while offering the secure, isolated, convenient application of joining audio synchronization with wireless signal group formation.

The processes described herein for group formation based on a synchronized response mechanism may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

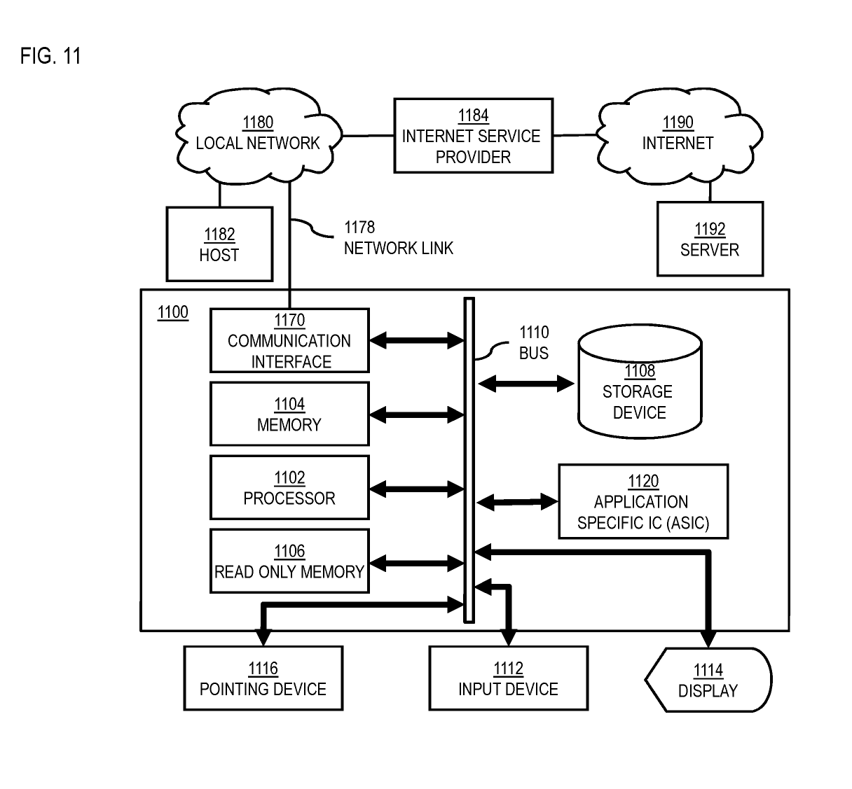

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to group formation based on a synchronized response mechanism as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of group formation based on a synchronized response mechanism.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to group formation based on a synchronized response mechanism. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1100 also includes a memory 1104 coupled to bus 1110. The memory 1104, such as a random access memory (RAM) or any other dynamic storage device, stores information including processor instructions for group formation based on a synchronized response mechanism. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for group formation based on a synchronized response mechanism, is provided to the bus 1110 for use by the processor from an external input device 1112, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114, and one or more camera sensors 1194 for capturing, recording and causing to store one or more still and/or moving images (e.g., videos, movies, etc.) which also may comprise audio recordings. In some embodiments, for example, in embodiments in which the computer system 1100 performs all functions automatically without human input, one or more of external input device 1112, display device 1114 and pointing device 1116 may be omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for group formation based on a synchronized response mechanism to the UE 101.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to group formation based on a synchronized response mechanism as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of group formation based on a synchronized response mechanism.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to group formation based on a synchronized response mechanism. The memory 1205 also stores the data associated with or generated by the execution of the inventive steps.

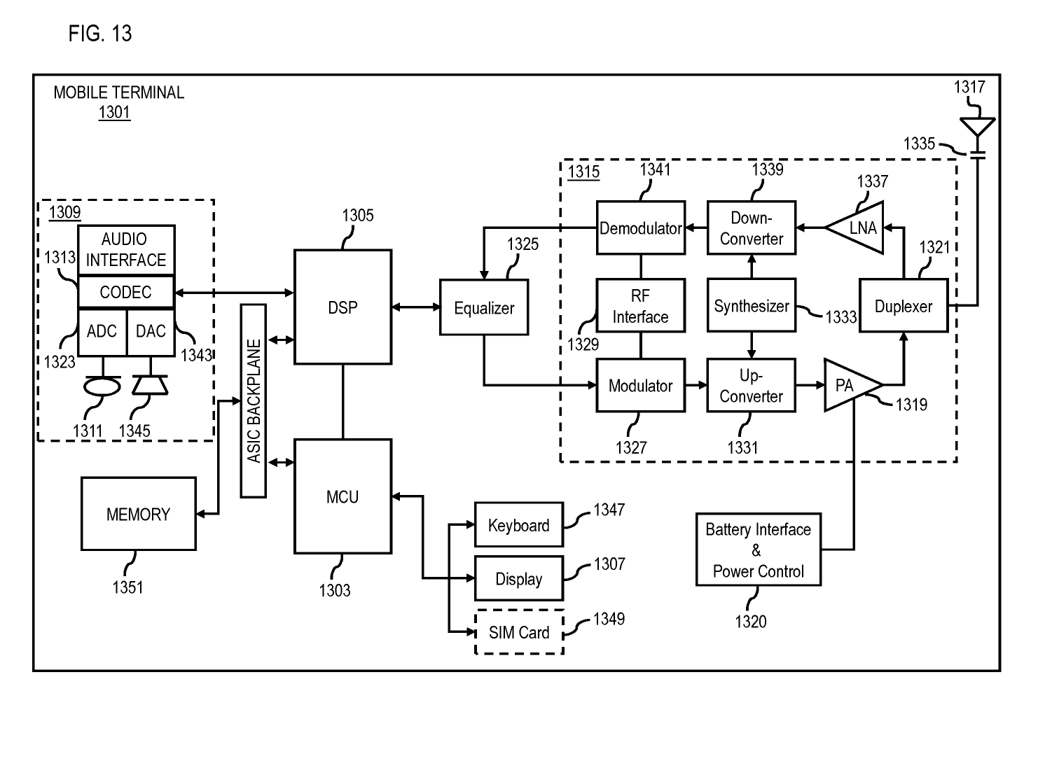

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of group formation based on a synchronized response mechanism. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of group formation based on a synchronized response mechanism. The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to group formation based on a synchronized response mechanism. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

Further, one or more camera sensors 1353 may be incorporated onto the mobile station 1301 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
determining a request to form at least one group of one or more devices;
causing, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time; and
causing, at least in part, a formation of the at least one group comprising the one or more devices that provide at least one response signal in reply to the at least one audio signal, the at least one visual signal, or a combination thereof at least substantially concurrently with the at least one synchronized response time.

2. A method of claim 1, wherein the (1) data and/or (2) information and/or (3) at least one signal are further based, at least in part, on the following:
causing, at least in part, a transmission of at least one message for the one or more devices to monitor for the at least one challenge signal,
wherein the at least one message includes, at least in part, the at least one synchronized response time.

3. A method of claim 1, wherein the (1) data and/or (2) information and/or (3) at least one signal are further based, at least in part, on the following:
causing, at least in part, an encoding of one or more validity criteria in the at least one challenge signal; and
determining a validity of at least one response signal based, at least in part, on whether the at least on response signal includes or meets the one or more validity criteria.

4. A method of claim 1, wherein the (1) data and/or (2) information and/or (3) at least one signal are further based, at least in part, on the following:
determining a validity of the at least one response signal based, at least in part, on whether a timing of the at least one audio signal, the at least one visual signal, or a combination thereof comprising the at least one response signal meets one or more timing criteria.

5. A method of claim 4, wherein the (1) data and/or (2) information and/or (3) at least one signal are further based, at least in part, on the following:
determining the timing criteria based, at least in part, on a maximum physical proximity for the formation of the at least one group.

6. A method of claim 1, wherein the (1) data and/or (2) information and/or (3) at least one signal are further based, at least in part, on the following:
causing, at least in part, a presentation of at least one group formation status signal by the one or more devices based, at least in part, on the formation of the at least one group, a validity of the at least one response signal, or a combination thereof.

7. A method of claim 6, wherein the at least one group formation status signal indicates a success or a failure of the formation of the at least one group with respect to one or more devices on a device-by-device basis.

8. A method of claim 6, wherein the at least one challenge signal, the at least one response signal, the at least one group formation status signal, or a combination thereof are presented in a combination of one or more overlapping signals.

9. A method of claim 8, wherein the combination of one or more overlapping signals comprise, at least in part, a melody, a harmony, or a combination thereof.

10. A method of claim 1, wherein the (1) data and/or (2) information and/or (3) at least one signal are further based, at least in part, on the following:
causing, at least in part, an adjustment of one or more elements of the at least one response signal,
wherein the one or more elements include, at least in part, a latency, a tempo, a pitch, a melody, or a combination thereof.

11. An apparatus comprising:
at least one processor; and
at least one memory including computer program code for one or more programs, the at least one memory and the computer program code configured to, with the at least one processor, cause the apparatus to perform at least the following,
determine a request to form at least one group of one or more devices;
cause, at least in part, a transmission of at least one challenge signal to the one or more devices, wherein the at least one challenge signal includes, at least in part, at least one audio signal, at least one visual signal, or a combination thereof, and wherein the transmission specifies at least one synchronized response time; and
cause, at least in part, a formation of the at least one group comprising the one or more devices that provide at least one response signal in reply to the at least one audio signal, the at least one visual signal, or a combination thereof at least substantially concurrently with the at least one synchronized response time.

12. An apparatus of claim 11, wherein the apparatus is further caused to:
cause, at least in part, a transmission of at least one message for the one or more devices to monitor for the at least one challenge signal,
wherein the at least one message includes, at least in part, the at least one synchronized response time.

13. An apparatus of claim 11, wherein the apparatus is further caused to:
cause, at least in part, an encoding of one or more validity criteria in the at least one challenge signal; and
determine a validity of at least one response signal based, at least in part, on whether the at least on response signal includes or meets the one or more validity criteria.

14. An apparatus of claim 11, wherein the apparatus is further caused to:
determine a validity of the at least one response signal based, at least in part, on whether a timing of the at least one audio signal, the at least one visual signal, or a combination thereof comprising the at least one response signal meets one or more timing criteria.

15. An apparatus of claim 14, wherein the apparatus is further caused to:
determine the timing criteria based, at least in part, on a maximum physical proximity for the formation of the at least one group.

16. An apparatus of claim 11, wherein the apparatus is further caused to:
cause, at least in part, a presentation of at least one group formation status signal by the one or more devices based, at least in part, on the formation of the at least one group, a validity of the at least one response signal, or a combination thereof.

17. An apparatus of claim 16, wherein the at least one group formation status signal indicates a success or a failure of the formation of the at least one group with respect to one or more devices on a device-by-device basis.

18. An apparatus of claim 16, wherein the at least one challenge signal, the at least one response signal, the at least one group formation status signal, or a combination thereof are presented in a combination of one or more overlapping signals.

19. An apparatus of claim 18, wherein the combination of one or more overlapping signals comprise, at least in part, a melody, a harmony, or a combination thereof.

20. An apparatus of claim 11, wherein the apparatus is further caused to:
cause, at least in part, an adjustment of one or more elements of the at least one response signal,
wherein the one or more elements include, at least in part, a latency, a tempo, a pitch, a melody, or a combination thereof.

21-48. (canceled)
